(19) United States
(12) Patent Application Publication
(10) Pub. No.: US 2018/0058390 A1
(43) Pub. Date: Mar. 1, 2018

(54) THREE CYLINDER HEAD FOR A DEDICATED EGR INTERNAL COMBUSTION ENGINE INCLUDING TWO PORTS

(71) Applicant: GM Global Technology Operations LLC, Detroit, MI (US)

(72) Inventors: Alan W. HAYMAN, Romeo, MI (US); Robert S. McALPINE, Lake Orion, MI (US)

(21) Appl. No.: 15/251,789

(22) Filed: Aug. 30, 2016

(51) Int. Cl. F02M 26/41; F02B 75/18; F02F 1/42

(52) U.S. Cl. CPC F02M 26/41; F02B 2075/1812; F02F 1/4264; F02B 75/18

(57) ABSTRACT

A cylinder head casting for a three cylinder engine having a dedicated exhaust gas recirculation cylinder and two non-dedicated cylinders, includes three combustion chamber upper wall portions. First and second exhaust ports/runners extend from two of the three combustion chamber upper wall portions, respectively, for the non-dedicated cylinders and are paired together prior to a first common breakout at an exhaust flange in a side face of the cylinder head. A third exhaust port/runner extends from the other of the three combustion chamber upper wall portions corresponding to the dedicated EGR cylinder remains separated from the first and second exhaust port runners until a separate second breakout at the exhaust flange.

### FIELD

The present disclosure relates to a three cylinder head for a dedicated EGR internal combustion engine that includes two ports.

### BACKGROUND AND SUMMARY

This section provides background information related to the present disclosure which is not necessarily prior art.

Internal combustion engines combust a mixture of air and fuel in cylinders and thereby produce drive torque. Combustion of the air-fuel mixture produces exhaust gases. In some internal combustion engines incorporating exhaust gas recirculation, a dedicated exhaust gas recirculation (EGR) cylinder has been employed to supply exhaust gases therefrom back into the air induction system.

According to the principles of the present disclosure, a cylinder head casting is provided for a three cylinder engine or a V-6 engine having a dedicated exhaust gas recirculation cylinder in which the exhaust ports/runners from two non-dedicated cylinders are paired prior to a first common port breakout from an exhaust flange of the cylinder head and so that the exhaust port/runner of the dedicated EGR cylinder remains separated until a second port breakout of the cylinder head at the exhaust flange.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic illustration of an engine assembly according to the principles of the present disclosure;

FIG. 2 is a schematic view of an exhaust flange of a cylinder head casting with port breakout at a same elevation; and

FIG. 3 is a schematic view of an exhaust flange of a cylinder head casting with port breakouts at staggered elevations.

Corresponding reference numerals indicate corresponding parts throughout the several views of the drawings.

### DETAILED DESCRIPTION

Example embodiments will now be described more fully with reference to the accompanying drawings.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

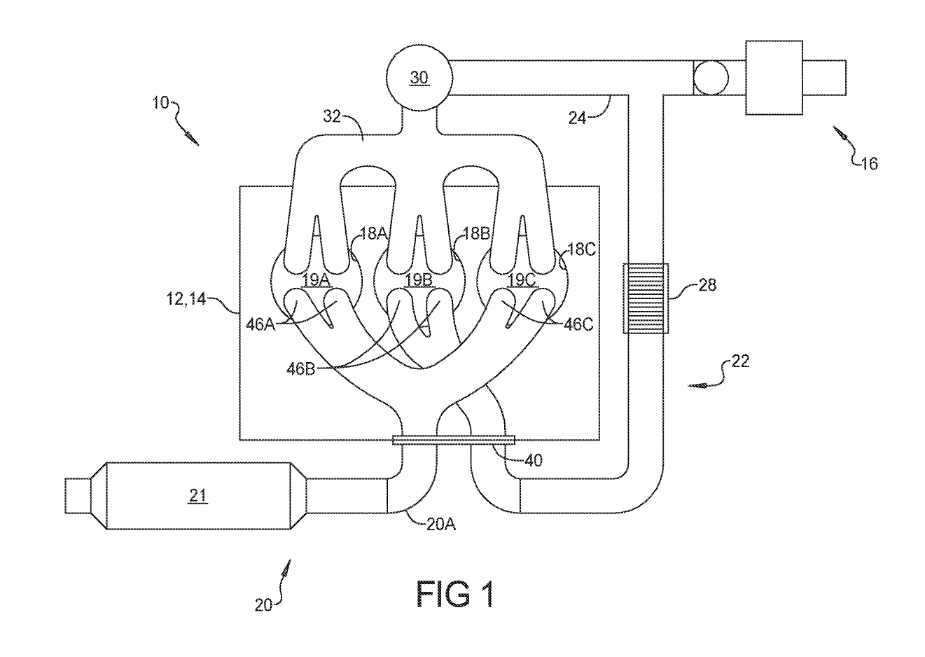

With reference to FIG. 1, an engine assembly 10 is shown and includes an engine structure including a cylinder head 12 connected to an engine block 14 as is known in the art. An air intake assembly 16 is in communication with the engine structure 12, 14 to supply intake air to the combustion chambers made up by the cylinders 18A-C of the engine block 14 and the combustion chamber upper wall portions 19A-19C of the cylinder head 12. The cylinders 18A-C include a dedicated exhaust gas recirculation cylinder 18B and two non-dedicated cylinders 18A, 18C. An exhaust system 20 is provided in communication with the non-dedicated cylinders 18A, 18C. The exhaust system 20 can include an exhaust passage 20A and an exhaust gas treatment catalyst and other noise attenuating devices 21. An exhaust gas recirculation passage 22 is provided in communication with the dedicated EGR cylinder 18B and with an air intake passage 24 of the air intake assembly 16. The exhaust gas recirculation passage 22 can include an exhaust gas recirculation cooler 28. The air intake assembly 16 can also include a booster in the form of a turbocharger or supercharger 30. An air intake manifold 32 is provided in communication with the air intake assembly 16 and the cylinders 18A-18C.

A side of the cylinder head 12 is provided with an exhaust flange 40 with two port breakouts 42, 44. The first port breakout 42 is in communication with the paired exhaust ports/runners 46A, 46C extending from the first and third combustion chamber upper wall portions 19A and 19C and the second port breakout 44 is in communication with the exhaust ports/runners 46B from the second combustion chamber upper wall portion 19B.

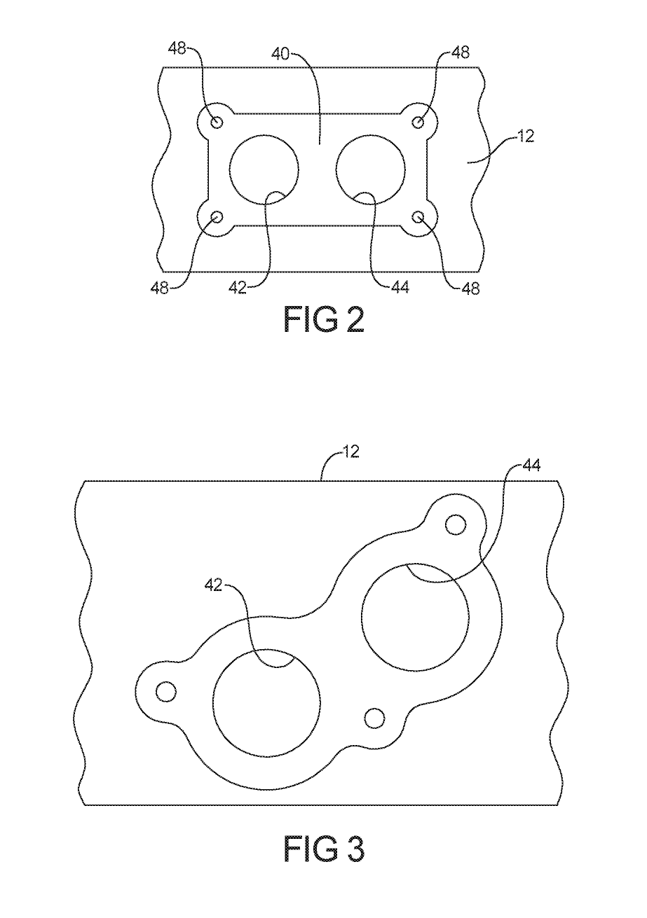

As illustrated in FIG. 2, the port breakouts 42, 44 can be provided on the same elevation or, alternatively, as shown in FIG. 3 can be at staggered elevations, i.e. with one of the two port breakouts 42, 44 being higher or lower than the other. With the port breakouts 42, 44 provided within a common exhaust flange 40, both the EGR passage 22 and exhaust passage 20 can be simultaneously connected to the exhaust flange 40 while maintaining separated connections. Each exhaust flange 40 includes a plurality of threaded apertures 48 associated therewith that are adapted to receive a threaded fastener for securing a common exhaust flange 50 connected to the exhaust passage 20A and the exhaust gas recirculation passage 22 to the exhaust flange 40 of the cylinder head 12.

The cylinder head arrangement 12 as shown and described can be utilized for an in-line 3 cylinder engine or incorporated in each bank of a V-6 cylinder head casting in which it is possible to cast the exhaust port/runners so that the two non-dedicated cylinders 18A, 18C are paired prior to the exit of the cylinder head 12 and so that the exhaust port/runner for the dedicated EGR cylinder 18B remains separated until the breakout 42, 44 of the cylinder head 12 at the exhaust flange 40. This allows for the exhaust of the dedicated EGR cylinder 18B to be routed through a control valve, a cooler and into the inlet system of the engine 10. It also allows the exhaust gases of the non-dedicated cylinders to be routed through the after treatment system 21 in the usual way.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

1. A cylinder head casting for a three cylinder engine having a dedicated exhaust gas recirculation cylinder and two non-dedicated cylinders, comprising;
three and only three combustion chamber upper wall portions; and
first and second pairs of exhaust ports/runners extending from a first and a second of the three combustion chamber upper wall portions, respectively, for the non-dedicated cylinders and all of the first and second pairs of exhaust ports/runners being paired together prior to a first common breakout at an exhaust flange in a side face of the cylinder head and a third pair of exhaust ports/runners of the dedicated EGR cylinder remain separated from the first and second pairs of exhaust port/runners until a separate second breakout at the exhaust flange.

2. The cylinder head casting according to claim 1, wherein the first breakout and the second breakout are disposed at a common elevation.

3. The cylinder head casting according to claim 1, wherein the first breakout and the second breakout are disposed at staggered elevations.

4. An internal combustion engine, comprising:
an engine block defining three and only three cylinders; and
a cylinder head casting including three and only three combustion chamber upper wall portions and first and second pairs of exhaust ports/runners extending from a first and a second of the three combustion chamber upper wall portions, respectively, and all of the first and second pairs of exhaust ports/runners being paired together prior to a first common breakout at an exhaust flange in a side face of the cylinder head and a third pair of exhaust ports/runners extending from the remaining combustion chamber upper wall portion and separated from the first and second pairs of exhaust ports/runners until a separate second breakout at the exhaust flange.

5. The internal combustion engine according to claim 4, wherein the first breakout and the second breakout are disposed at a common elevation.

6. The internal combustion engine according to claim 4, wherein the first breakout and the second breakout are disposed at staggered elevations.
